(19) United States
(12) Patent Application Publication
(10) Pub. No.: US 2004/0057560 A1
(43) Pub. Date: Mar. 25, 2004

(54) Telephony device, base station device and communication method

(76) Inventor: Tsuyoshi Nakamura, Kasuya-Gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/634,855

(22) Filed: Aug. 6, 2003

(30) Foreign Application Priority Data
Aug. 9, 2002 (JP) 2002-232902

(51) Int. Cl. H04M 11/00; H04M 1/00

(52) U.S. Cl. 379/88.13; 379/373.01

(57) ABSTRACT

The image composing unit 73 composes an image expressing transmission source information and an image expressing transmission destination information. The image encoding unit 74 encodes this composed image. The sound encoding unit 77 encodes sound expressing information of transmission source and transmission destination. The multiplexing unit 76 multiplexes encoded composed image and encoded sound. The connection control unit 9, before an off-hook of a transmission destination telephony device, transmits this multiplexed signal. The transmission destination telephony device, before an off-hook, displays an image. The image includes an image expressing transmission source information and an image expressing transmission destination information. The transmission destination telephony device outputs sound expressing information of a transmission source and a transmission destination before an off-hook.

### BACKGROUND OF THE INVENTION

1. Filed of the Invention

The present invention relates to a telephony device, a base station device that relays the transmission, and an art related thereto.

2. Description of the Related Art

In the modern society, there are telephony-related problems, such as phone calls by notorious sales representatives and notorious calls by stalkers. Therefore, before a receiver is connected to a caller on the phone, the receiver wants to confirm who the caller is, and then answers the phone.

In Japan, an advertisement of a service was distributed in around March, 2002. The service is displaying a caller's name and phone number on a telephony device. The service has started since the beginning of July, 2002.

Thus, after looking at the caller's name and his/her phone number on the telephony device, the receiver can decide whether or not the receiver will answer the call.

Even though a caller's name and phone number are displayed, there are some situations that a receiver may not be able to determine if he/she should pick up the phone.

When a receiver does not clearly remember the name, when a receiver wants to take a look at the caller's face, and when a receiver wants to determine after checking out the product even it is a sales call are the examples of the situations on the above.

### OBJECTS AND SUMMERY OF THE INVENTION

A first object of the present invention is to provide a telephony device that gives users more precise decision-making about answering phone calls and the art related thereto.

A second object of the present invention is to provide a telephony device which can give users a precise response before answering phone calls and the art related thereto.

A first aspect of the present invention provides a telephony device comprising a transmission unit operable to transmit multimedia information to a transmission destination telephony device before an off-hook of the transmission destination telephony device.

According to this construction above, the multimedia information is transmitted from the present telephony device of the transmission destination to the transmission source telephony device.

Therefore, a user of this transmission source telephony device can transmit multimedia information according to a transmission destination.

This multimedia information is transmitted before an off-hook of the transmission source telephony device.

As a result, before the telephony device user of the transmission destination answers the phone call, the user can cope precisely.

A second aspect of the present invention provides a telephony device comprising an image display unit operable to display, before an off-hook, information based on multimedia information transmitted by a transmission source telephony device.

According to this construction above, this telephony device of the transmission destination can display information based on multimedia information that the transmission source telephony device transmits according to the transmission destination, before an off-hook.

As a result, before this telephony device user of the transmission destination answers the phone call, the user can cope precisely.

A third aspect of the present invention provides a telephony device comprising a transmission unit operable to transmit, before an off-hook of a transmission source telephony device, an image expressing transmission source information.

According to this construction, the image expressing of the transmission source information is transmitted from this transmission source telephony device to a transmission destination telephony device.

Thus, a user of this transmission source telephony device can transmit an arbitrary image expressing transmission source information according to a transmission destination.

This image expressing transmission source information is transmitted before an off-hook of the transmission destination telephony device.

As a result, before a telephony device user of the transmission destination answers the phone call, the user can determine precisely if or not he/she wants to talk on the phone.

Because this transmission source telephony device transmits the image expressing transmission source information, the degree of flexibility expressing transmission source information is greater as compared with the case where the character information is transmitted.

A fourth aspect of the present invention as defined in the third aspect of the present invention provides a telephony device, wherein the transmission unit transmits, before an off-hook of a transmission destination telephony device, an image expressing transmission destination information to the transmission destination telephony device.

According to this construction above, the transmission destination telephony device can display an image expressing the transmission destination information transmitted from this transmission source telephony device before an off-hook.

As a result, before answering a call, a telephony device user of the transmission destination can determine if a caller has got a wrong number or not.

Because this transmission source telephony device transmits the image expressing the transmission destination information, the degree of flexibility expressing the transmission destination information is greater as compared with the case where the character information is transmitted.

A fifth aspect of the present invention provides a telephony device for transmitting an image based on received information to a transmission destination telephony device via a base station device to communicate with the transmission destination telephony device, the telephony device comprising a transmission unit operable to transmit, before an off-hook of the transmission destination telephony device, transmission source information to the base station device, wherein the base station device acquires the image based on the received information.

According to this construction above, the transmission source information is transmitted from this transmission source telephony device to the base station device, and then is transmitted to the transmission destination telephony device as an image.

Therefore, a user of the transmission source telephony device can transmit an arbitrary image expressing transmission source information according to a transmission destination.

The transmission destination telephony device can display the image expressing the transmission source information based on a transmission destination before an off-hook.

As a result, before a telephony device user of the transmission destination answers the phone call, the user can precisely determine if or not he/she wants to talk on the phone.

The image expressing the transmission source information is finally transmitted to the transmission destination telephony device.

The degree of flexibility expressing the transmission source information is greater as compared with the case where character information is transmitted.

A sixth aspect of the present invention as defined in the fifth aspect of the present invention provides a telephony device, wherein the transmission unit transmits, before the off-hook of the transmission destination telephony device, transmission destination information to the base station device, and wherein the base station device acquires, according to the transmission destination information, the image based on the received information.

According to this construction above, the transmission destination information is transmitted from this transmission source telephony device to the base station device, and then is transmitted to the transmission destination telephony device as an image.

Thus, the transmission destination telephony device can display an image expressing the transmission destination information that is transmitted from the transmission source before an off-hook

Before answering a call, a telephony device user of the transmission destination can determine if a caller has got a wrong number or not.

The image expressing the transmission destination information is finally transmitted to the transmission destination telephony device.

The degree of flexibility expressing the transmission destination information is greater as compared with the case where character information is transmitted.

A seventh aspect of the present invention provides a telephony device comprising an image display unit operable to display, before an off-hook, an image expressing transmission source information transmitted by a transmission source telephony device.

According to this construction above, before an off-hook, this telephony device of the transmission destination can display an arbitrary image expressing transmission source information, which the transmission source telephony device transmits according to a transmission destination.

As a result, before a telephony device user of the transmission destination answers the phone call, the user can precisely determine if or not he/she wants to talk on the phone.

An eighth aspect of the present invention as defined in the seventh aspect of the present invention provides a telephony device, wherein the image display unit displays, before the off-hook, an image expressing transmission destination information transmitted by the transmission source telephony device.

According to this construction above, before answering a call, a telephony device user of the transmission destination can determine if a caller has got a wrong number or not.

A ninth aspect of the present invention provides a telephony device comprising an image display unit operable to display, before an off-hook, an image acquired by a base station device relaying communications between a transmission source telephony device and the telephony device, wherein the base station acquires the image based on transmission source information.

According to this construction above, this transmission destination telephony device can display an image acquired by the base station device based on arbitrary transmission source information, which a destination source telephony device transmits according to a transmission destination.

As a result, before a telephony device user of the transmission destination answers the phone call, the user can precisely determine if or not he/she wants to talk on the phone.

A tenth aspect of the present invention as defined in the ninth aspect of the present invention provides a telephony device, wherein the image display unit displays, before the off-hook, an image that has acquired based on transmission destination information transmitted by the transmission source telephony device.

According to this construction above, before answering a call, a telephony device user of the transmission destination can determine if a caller has got a wrong number or not.

An eleventh aspect of the present invention provides a telephony device comprising: a first image generating unit operable to generate an image based on transmission source information transmitted by a transmission source telephony device; and an image display unit operable to display the image before an off-hook.

According to this construction above, before a telephony device user of the transmission destination answers the phone call, the user can precisely determine if or not he/she wants to talk on the phone.

A twelfth aspect of the present invention as defined in the eleventh aspect of the present invention provides a telephony device, further comprising a second image generating unit operable to generate an image based on transmission destination information transmitted by the transmission source telephony device, wherein the image display unit displays, before the off-hook, the image generated by the second image generating unit.

According to this construction above, before answering a call, a telephony device user of the transmission destination can determine if a caller has got a wrong number or not. A thirteenth aspect of the present invention as defined in the third aspect of the present invention provides a telephony device, wherein the image expressing the transmission source information comprises a face image.

According to this construction above, in the transmission destination, recognition of the caller, who is the transmission source, becomes even easier.

A fourteenth aspect of the present invention as defined in the fifth aspect of the present invention provides a telephony device, wherein the image based on the received information comprises a face image.

According to this construction above, in a transmission destination, recognition of the caller, who is the transmission source, becomes even easier.

A fifteenth aspect of the present invention provides a telephony device comprising a transmission unit operable to transmit, before an off-hook of a transmission destination telephony device, sound signals expressing transmission source information.

According to this construction above, the sound expressing the transmission source information is transmitted to the transmission destination telephony device from this transmission source telephony device.

Therefore, a user of this transmission source telephony device can transmit arbitrary sound expressing transmission source information according to a transmission destination.

This sound expressing the transmission source information is transmitted before an off-hook of the transmission destination telephony device.

As a result, before a telephony device user of the transmission destination answers the phone call, the user can precisely determine if or not he/she wants to talk on the phone.

A sixteenth aspect of the present invention as defined in the fifteenth aspect of the present invention provides a telephony device, wherein the transmission unit transmits, before the off-hook, sound signals expressing transmission destination information.

According to this construction above, the transmission destination telephony device can output sound expressing the transmission destination information, which is transmitted from this transmission source telephony device before an off-hook.

As a result, before answering a call, a telephony device user of the transmission destination can determine if a caller has got a wrong number or not.

A seventeenth aspect of the present invention as defined in the seventh aspect of the present invention provides a telephony device, further comprising a connection control unit operable to transmit, after the off-hook, a predetermined image to the transmission source telephony device to cut off communications between the transmission source telephony device and the telephony device.

According to this construction above, this telephony device can cut off a communication without having a conversation with the caller, who is the transmission source, and can notify the transmission source about the reason for cutoff as a predetermined image.

An eighteenth aspect of the present invention provides a telephony device, further comprising a connection control unit operable to transmit, after the off-hook, predetermined sound signals to the transmission source telephony device to cut off communications between the transmission source telephony device and the telephony device.

According to this construction above, this telephony device can cut off communication without having a conversation with the caller, who is the transmission source, and can notify the transmission source about the reason for cutoff as predetermined sound.

A nineteenth aspect of the present invention provides a telephony device for transmitting sound signals based on received information to a transmission destination telephony device via a base station device to communicate with the transmission destination telephony device, the telephony device comprising a transmission unit operable to transmit, before an off-hook of the transmission destination telephony device, transmission source information to the base station device, wherein the base station device acquires the sound signals based on the transmission source information.

According to this construction above, the transmission source information is transmitted from this transmission source telephony device to the base station device, and then is transmitted to the transmission destination telephony device as sound.

A telephony device user of the transmission destination can output sound expressing arbitrary information of the transmission destination according to a transmission destination.

The transmission destination telephony device can output sound expressing transmission source information according to a transmission destination.

As a result, before a telephony device user of the transmission destination answers the phone call, the user can precisely determine if or not he/she wants to talk on the phone.

A twentieth aspect of the present invention provides a base station device comprising: a first acquiring unit operable to acquire an image based on transmission source information transmitted by a transmission source telephony device; and a transmission unit operable to transmit, before an off-hook of a transmission destination telephony device, the image acquired by the first acquiring unit to the transmission destination telephony device.

According to this construction above, in the transmission destination telephony device, an image acquired by the base station device is based on arbitrary transmission source information that the transmission source telephony device transmits according to a transmission destination, can be displayed before an off-hook.

As a result, before a telephony device user of the transmission destination answers the phone call, the user can precisely determine if or not he/she wants to talk on the phone.

A 21st aspect of the present invention as defined in the twentieth aspect of the present invention provides a base station device, wherein the image acquired by the first acquiring unit comprises a face image.

According to this construction above, in a transmission destination, recognition of the caller, who is the transmission source, becomes even easier.

A 22nd aspect of the present invention as defined in the twentieth aspect of the present invention provides a base station device of claim 24, further comprising a second acquiring unit operable to acquire an image based on transmission destination information transmitted by the transmission source telephony device, wherein the transmission unit transmits, before the off-hook, the image acquired by the second acquiring unit to the transmission destination telephony device.

According to this construction above, before answering a call, a telephony device user of the transmission destination can determine if a caller has got a wrong number or not.

A 23rd aspect of the present invention provides a base station device comprising: an acquiring unit operable to acquire sound signals based on transmission source information transmitted by a transmission source telephony device; and a transmission unit operable to transmit, before an off-hook, the sound signals to a transmission destination telephony device.

According to this construction above, in the transmission destination telephony device, sound acquired by the base station device is based on arbitrary transmission source information that the transmission source telephony device transmits according to a transmission destination, can be outputted before an off-hook.

As a result, before a telephony device user of the transmission destination answers the phone call, the user can precisely determine if or not he/she wants to talk on the phone.

A 24th aspect of the present invention as defined in the twentieth aspect of the present invention provides a base station device, further comprising a connection control unit, wherein the transmission unit transmits, after the off-hook, a predetermined image to the transmission source telephony device according to a cut off request signal transmitted by the transmission destination telephony device, and wherein the connection control unit cuts communications off between the transmission source telephony device and the transmission destination telephony device.

According to this construction above, the communication can be cut off without having a conversation with the opponent that is the transmission source. The reason for the cutoff can be also notified to the transmission source as a predetermined image.

A 25th aspect of the present invention as defined in the twentieth aspect of the present invention provides a base station device, further comprising a connection control unit, wherein the transmission unit transmits, after the off-hook, predetermined sound signals to the transmission source telephony device according to a cut off request signal transmitted by the transmission destination telephony device, and wherein the connection control unit cuts communications off between the transmission source telephony device and the transmission destination telephony device.

According to this construction above, the communication can be cut off without having a conversation with the opponent that is the transmission source. The reason for the cutoff can be also notified to the transmission source as a predetermined image.

A 26th aspect of the present invention provides a communication method comprising transmitting multimedia information to a transmission destination telephony device before an off-hook of the transmission destination telephony device.

According to this construction above, the multimedia information is transmitted to a transmission destination telephony device from this transmission source telephony device.

Thus, a user of this transmission source telephony device can transmit multimedia information according to a transmission destination.

This multimedia information is transmitted before an off-hook of the transmission destination telephony device.

As a result, before a telephony device user of the transmission destination answers the phone call, the user can precisely determine if or not he/she wants to talk on the phone.

“Acquiring” an image includes “generating” an image.

Still picture information, moving picture information, audio information, sound information, text information, a program, or a combination of these are the examples of “multimedia information”.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram, illustrating a telephony device according to a first embodiment of the present invention;

FIG. 2 is a flowchart, illustrating a transmission processing according to the first embodiment of the present invention;

FIG. 3 is a flowchart, illustrating a reception processing according to the first embodiment of the present invention;

FIG. 4 is a flowchart, illustrating a cutoff processing according to the first embodiment of the present invention;

FIG. 5(a) is an illustration figure, showing a transmission destination image according to the first embodiment of the present invention;

FIG. 5(b) is an illustration figure, showing a first transmission source image according to the first embodiment of the present invention;

FIG. 5(c) is an illustration figure, showing a second transmission source image according to the first embodiment of the present invention;

FIG. 5(d) is an illustration figure, showing a composed image according to the first embodiment of the present invention;

FIG. 6 is an illustration figure, showing the said chip construction according to the first embodiment of the present invention;

FIG. 7 is a block diagram, illustrating a communication system according to a second embodiment of the present invention;

FIG. 8 is a block diagram, illustrating a telephony device according to the second embodiment of the present invention;

FIG. 9 is a flowchart, illustrating a transmission processing of a telephony device according to the second embodiment of the present invention;

FIG. 10 is a flowchart, illustrating a cutoff processing of a telephony device according to the second embodiment of the present invention;

FIG. 11 is a block diagram, illustrating a base station device according to the second embodiment of the present invention;

FIG. 12 is a flowchart, illustrating a processing of a base station device according to the second embodiment of the present invention;

FIG. 13 is a flowchart, illustrating a cutoff processing of a base station device according to the second embodiment of the present invention;

FIG. 14 is a block diagram, illustrating a telephony device according to a third embodiment of the present invention;

FIG. 15 is a flowchart, illustrating a reception processing according to the third embodiment of the present invention.

### DETAILED DESCRIPTION OF THE PREFERRED EMBODIMENTS

Embodiments of the present invention will now be described with reference to the drawings.

### First Embodiment

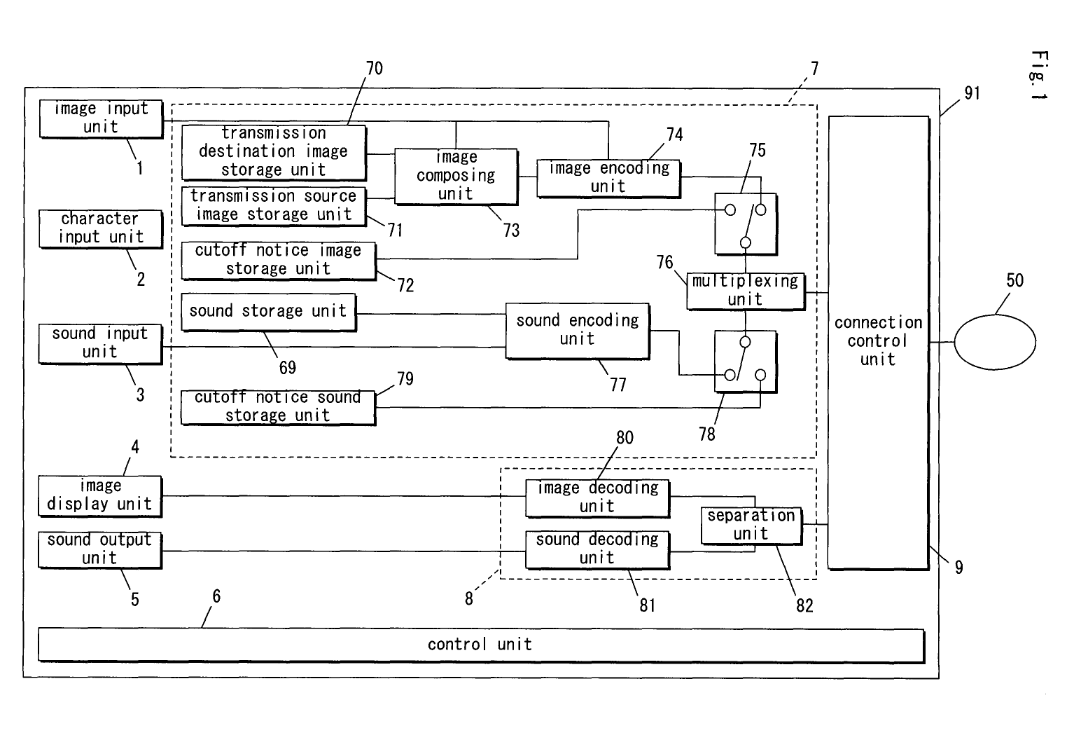

FIG. 1 is a block diagram, illustrating a telephony device according to the first embodiment.

For example, this telephony device is a TV telephone device.

This telephony device also includes IP telephones.

As shown in FIG. 1, this telephony device 91 comprises an image input unit 1, a character input unit 2, a sound input unit 3, an image display unit 4, a sound output unit 5, a control unit 6, a transmission unit 7, a receiving unit 8, and a connection control unit 9.

The transmission unit 7 includes a transmission destination image storage unit 70, a transmission source image storage unit 71, a cutoff notice image storage unit 72, an image composing unit 73, an image encoding unit 74, a switch unit 75, a multiplexing unit 76, a sound decoding unit 77, a switch unit 78, a cutoff notice sound storage unit 79, and a sound storage unit 69.

The receiving unit 8 includes an image decoding unit 80, a sound decoding unit 81, and a separation unit 82.

Functions and operations of each construction are explained.

The control unit 6 controls each construction of the telephony device 91.

The image input unit 1 takes a picture of a subject, and then converts the optical image into an electrical signal (an image signal).

The image unit1 is, for example, a CCD (charge coupled device) camera.

The character input unit 2 inputs character information.

The character input unit 2 is, for example, an arrangement of a plural push-button switch.

The sound input unit 3 converts inputted sound into electrical signals (sound signals).

The sound input unit 3 is, for example, a microphone.

The image display unit 4 displays an image corresponding to an inputted image signal.

The image display unit 4 is, for example, LCD (liquid crystal display).

The sound output unit 5 converts inputted sound signals into sound, and then outputs the sound to the outside.

The sound output unit 5 is, for example, a speaker.

The connection control 9, in accordance with an instruction of the control unit 6, sends out information inputted from the transmission unit 7 to the network 50 or outputs the information inputted by the network 50 to the reception unit 8.

The transmission unit 7 is explained.

The transmission destination image storage unit 70 stores an image signal expressing the transmission destination information.

The transmission destination image storage unit 70 stores a face image, a name and a phone number of a telephony device user that can be a transmission destination from the telephony device 91.

The transmission destination image storage unit 70 also stores characters such as names as an image.

The transmission source image storage unit 71 stores an image signal expressing transmission source information.

The transmission source image storage unit 71 stores a face image, a name and a phone number of the telephony device 91 user.

The transmission source image storage unit 71 also stores characters such as names as an image.

When communication is refused, the cutoff notice image storage unit 72 stores an image signal for notifying the refusal (the image signal is referred to a “cutoff notice image” as follows.)

The cutoff notice image storage unit 72 stores a cutoff notice image, which is “You've got a wrong number. The telephone number this place is ∘∘∘.”

In the present embodiment, assume that the cutoff notice image storage unit 72 stores an encoded cutoff notice image.

Because of this, an encoding processing of the cutoff notice image is unnecessary, and the processing can be simplified.

The sound storage unit 69 stores sound signals expressing information only for a transmission source, sound signals expressing information only for a transmission destination, or sound signals expressing information for both a transmission source and a transmission destination.

The sound storage unit 69 is capable of;

storing sound expressing a name of the telephony device 91 user of the transmission source;

storing sound expressing a name of the telephony device user that can be the transmission destination, and

storing sound expressing a name of the telephony device 91 that can be the transmission source, and sound expressing a name of the telephony user device user that can be the transmission destination.

When sound signals expressing information only for a transmission source, sound signals expressing only for a transmission destination, and sound signals expressing information for both a transmission source and a transmission destination are generated as one, it is expressed as “sound expressing information of a transmission source/a transmission destination”.

When communication is refused, the cutoff notice sound storage unit 79 stores sound signals for notifying the refusal (the sound signals are referred to “cutoff notice sound” as follows.)

The cutoff notice sound storage unit 79 stores cutoff notice sound, which is “You've got a wrong number. The telephone number this place is ∘∘∘.”

In the present embodiment, assume that the cutoff notice sound storage unit 79 stores encoded cutoff notice sound.

Because of this, an encoding processing of the cutoff notice sound is unnecessary, and the processing can be simplified.

The image composing unit 73 follows an instruction of the control unit 6, and composes two of or all of an image inputted from the image input unit 1, an image read out from the transmission destination image storage unit 70, and an image read out from the transmission source image storage unit 71

The image encoding unit 74 follows an instruction of the control unit 6, and encodes an image inputted from the image input unit 1 or a composed image that the image composition unit 73 generated.

The switch unit 75 follows an instruction of the control unit 6, and outputs either an image encoded by the image encoding unit 74 or an image read out from the cutoff notice image storage unit 72.

The sound encoding unit 77 follows an instruction of the control unit 6, and encodes sound read out from the sound storage unit 69 or sound inputted from the sound input unit 3.

The switch unit 78 follows an instruction of the control unit 6, and outputs either sound encoded by the sound encoding unit 77 or sound read out from the cutoff notice sound storage unit 79 to the multiplexing unit 76.

The multiplexing unit 76 follows an instruction of the control unit 6, and multiplexes an encoded image inputted from the switch unit 75 and encoded sound inputted from the switch unit 78.

The connection control unit 9 follows an instruction of the control unit 6, and sends out an encoded image multiplexed by the multiplexing unit 76 and encoded sound to the network 50.

The receiving unit 8 is explained.

The separation unit 82 follows an instruction of the control unit 6, and separates a multiplexed encoded image signal inputted from the connection control unit 9 and encoded sound signals.

The image decoding unit 80 decodes an encoded image signal separated by the separation unit 82, and outputs the decoded image signal to the image display unit 4.

The sound decoding unit 81 decodes encoded sound signals separated by the separation unit 82, and outputs the decoded sound signals to the sound output unit 5.

The transmission destination image storage unit 70, the transmission source image storage unit 71, the cutoff notice image storage unit 72, the sound storage unit 69, and the cutoff notice sound storage unit 79 not only can be built in the telephony device 91, but also can be used by constructing as an external storage unit and by attaching to the telephony device 91.

An image expressing transmission destination information stored in the transmission destination image storage unit 70 can be used as an image taken in the image input unit 1, an image taken in the other image input unit, an image expressing character information inputted in the character input unit 2, an image expressing character information inputted in the other character input unit 2 and so on.

An image expressing transmission source information stored in the transmission source image storage unit 71 can be used as an image taken in the image input unit 1, an image taken in the other image input unit, an image expressing character information inputted in the character input unit 2, an image expressing character information inputted in the other character input unit 2 and so on.

A cutoff notice image stored in the transmission source image storage unit 72 can be used as an image expressing character information input in the character input unit 2, an image expressing character information input in the other character input unit 2 and so on.

Sound expressing information of a transmission source/a transmission destination stored in the sound storage unit 71 can be used as sound inputted from the sound input unit 3, sound inputted from the other sound input unit and so on.

Cutoff notice sound stored in the cutoff notice sound storage unit 79 can be used as sound inputted from the sound input unit 3, sound inputted from the other sound input unit and so on.

A flow of the entire processing is now described using a flowchart.

A transmission processing is explained.

The telephony device 91 is assumed as a transmission source (a transmitting side).

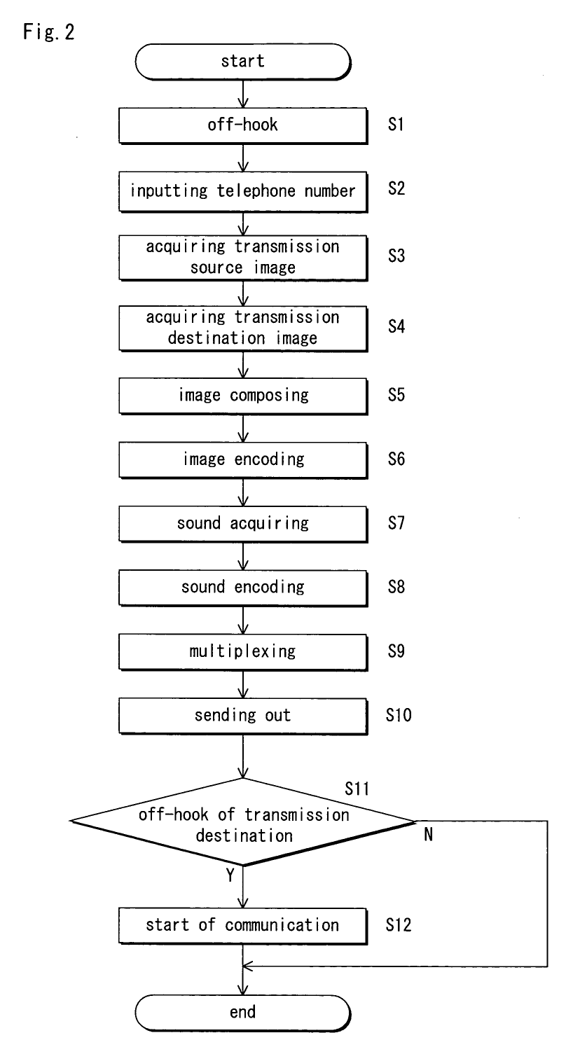

FIG. 2 is a flowchart, illustrating a transmission processing.

As shown in FIG. 2, the telephony device 91 (that is a transmission source) is hooked off.

In step S2, a telephone number of the transmission destination is inputted from the character input unit 2.

In step S3, the image composing unit 73 follows an instruction of the control unit 6, and acquires an image expressing transmission source information only from the image input unit 1, only from the transmission source image storage unit 71, or from both of the image input unit 1 and the transmission source image storage unit 71.

In step S4, the image composing unit 73 follows an instruction of the control unit 6, and acquires an image expressing the transmission destination information from the transmission destination image storage unit 70.

In step S5, the image composing unit 73 follows an instruction of the control unit 6, and composes an image expressing the transmission source information and an image expressing the transmission destination information, and then generates a composed image.

In step S6, the image encoding unit 74 follows an instruction of the control unit 6, and encodes a composed image that the image composing unit 73 generates.

The switch unit 75 follows an instruction of the control unit 6, and outputs this encoded composed image into the multiplexing unit 76.

In step S7, the sound encoding unit 77 follows an instruction of the control unit 6, and acquires sound expressing information of the transmission source/the transmission destination from the sound input unit 3 or the sound storage unit 69.

In step S8, the sound encoding unit 77 follows an instruction of the control unit 6, and encodes sound expressing information of the transmission source/the transmission destination.

The a switch unit 78 follows an instruction of the control unit 6, and outputs this encoded sound expressing information of the transmission source/the transmission destination to the multiplexing unit 76.

In step S9, the multiplexing unit 76 follows an instruction of the control unit 6, and multiplexes an encoded composed image and encoded sound expressing information of the transmission source/the transmission destination, and then outputs to the connection control unit 9 as a multiplexing signal.

In step S10, the connection control unit 9 follows an instruction of the control unit 6, and sends out this multiplexing signal to the network 50.

This multiplexing signal is transmitted to a telephony device of the transmission destination via the network 50, and is performed a certain processing. This multiplexing signal is then displayed on a transmission destination telephony device before an off-hook of the transmission destination telephony device.

This reception processing is explained in detail later.

In step S11, when a transmission destination telephony device connected to the network 50 is hooked off, communication is started in step S12.

After this, the image encoding unit 74 follows an instruction of the control unit 6, and encodes an image inputted from the image input unit 1.

The switch unit 75 follows an instruction of the control unit 6, and outputs this encoded image to the multiplexing unit 76.

On the other hand,

The sound encoding unit 77 follows an instruction of the control unit 6, and encodes sound inputted from the sound input unit 3.

The switch unit 78 follows an instruction of the control unit 6, and outputs the encoded sound to the multiplexing unit 76.

The multiplexing unit 76 multiplexes an encoded image and encoded sound, and then outputs to the connection control unit 9 as a multiplexing signal.

The connection control unit 9 sends out the multiplexing signal to the network 50.

On the other hand, in step S12, when a telephony device of the transmission destination is hooked on, the communication can not be made.

The processing order of step S3 and step S4 is not limited as written here, but a concurrent processing is also possible.

The processing order of step S3 through S6, step S7 and step S8 is not limited as written here, but a concurrent processing is also possible.

An off-hook of step S1 can be performed before a sending out of step S10, and it is not limited in order of FIG. 2.

A receiving processing is explained.

The telephony device is assumed as a transmission destination (a receiving side).

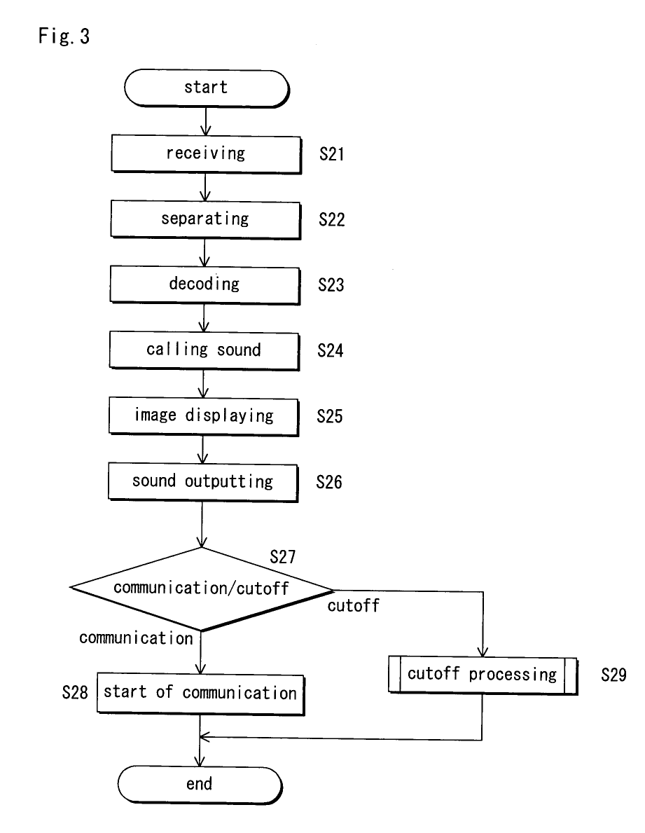

FIG. 3 is a flowchart illustrating the receiving processing.

As shown in FIG. 3, in step S21, the connection control unit 9 receives a multiplexed signal transmitted from a telephony device (that is a transmission source) that is connected to the network 50.

This multiplexed signal is a signal multiplexed of a composed image expressing the transmission source information and an image expressing the transmission destination information, and sound expressing information of the transmission source/the transmission destination.

In step S22, the separation unit 82 follows an instruction of the control unit 6, and separates the multiplexed signal into a composed image expressing the transmission source information and an image expressing the transmission destination information, and sound expressing information of the transmission source/the transmission destination.

In step S23, the image decoding unit 80 follows an instruction of the control unit 6, and decodes the separated composed image by the separation unit 82.

The sound decoding unit 81 follows an instruction of the control unit 6, and decodes separated sound expressing information of the transmission source/the transmission destination by the separation unit 82.

In step S24, according to an instruction of the control unit 6, calling sound is made from the sound output unit 5.

In step S25, the image display unit 4 follows an instruction of the control unit 6, and displays a decoded composed image of an image expressing the transmission source information and an image expressing the transmission destination information.

In step S26, the sound output unit 5 follows an instruction of the control unit 6, and outputs decoded sound expressing information of the transmission source/the transmission destination.

In step S27, when the telephony device 91 (that is a transmission destination) is hooked off, and the control unit 6 gives an instruction of start of a call, it is possible to start a call in step S28.

After this, an image, which a transmission destination telephony device connected to the network 50 transmits, is displayed on the image display unit 4 via the connection control unit 9, the separation unit 82, and the image decoding unit 80. Sound, which a transmission destination telephony device connected to the network 50 transmits, is outputted from the sound output unit 5 via the connection control unit 9, the separation unit 82, and the sound decoding unit 81.

In step S27, when an instruction of cutoff is given by the control unit 6, a cutoff processing is performed in step S28.

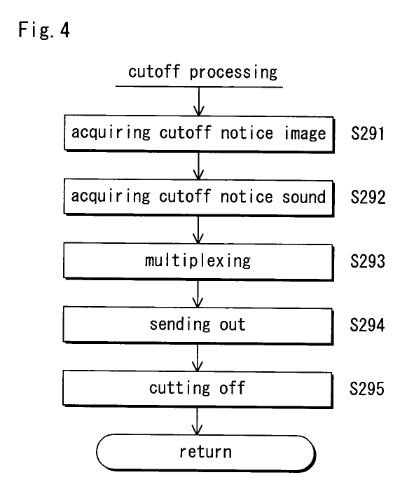

FIG. 4 is a flowchart, illustrating a cutoff processing according to step S 29 of FIG. 3.

As shown in FIG. 4, in step S291, the multiplexing unit 76 follows an instruction of the control unit 6, and acquires an encoded cutoff notice image from the cutoff notice image storage unit 72 via the switch unit 75.

In step S292, the multiplexing unit 76 follows an instruction of the control unit 6, and acquires encoded cutoff notice sound from the cutoff notice sound storage unit 79 via the switch unit 78.

In step S293, the multiplexing unit 76, according to an instruction of the control unit 6, multiplexes the encoded cutoff notice image and the encoded cutoff notice sound, and outputs to the connection control unit 6 as a multiplexing signal.

In step S294, when the telephony device 91 is hooked off, the connection control unit 9, in accordance with an instruction of the control unit 6, sends out this multiplexing signal to the network 50.

In a transmission source telephony device, a cutoff notice image is displayed, and a telephony device user of a transmission source can understand the reason for a cutoff.

In step S295, the telephony device 91 is hooked on, and a communication is cut off.

The processing order of step S25 and step S26 in FIG. 3 is not limited as written here, but a concurrent processing is also possible.

Calling sound can be made not only after step S23 of FIG. 3, but can be also made after receiving.

The processing order of step S291 and step S292 of FIG. 4 is not limited as written here, but a concurrent processing is also possible.

More detailed examples of an image expressing transmission source information and an image expressing transmission destination information are explained.

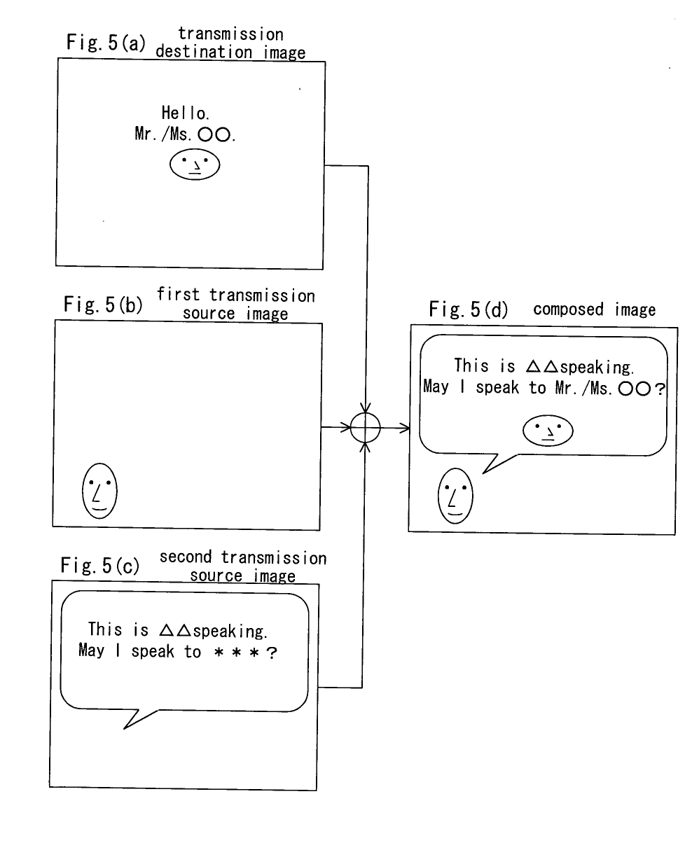

FIG. 5(a) is an illustration figure, showing transmission destination information.

In FIG. 5(a), a user's face image of a transmission destination telephony device and an image expressing a user name of a transmission destination telephony device are exemplified as an image expressing transmission destination information.

Such an image expressing transmission destination information is stored in the transmission destination image storage unit 70.

FIG. 5(b) is an illustration figure, showing a first image expressing transmission source information.

In FIG. 5(b), a user's face image of a transmission source telephony device is exemplified as a first image expressing the transmission source information.

Such a first image expressing the transmission source information is stored in the transmission source image storage unit 71.

Or, an image inputted from the image input unit 1 can be used as the first image expressing the transmission source information.

FIG. 5(c) is an illustration figure, showing a second image expressing transmission source information.

In FIG. 5(c), a user name of a transmission source telephony device is exemplified as a second image expressing the transmission source information.

Such a second image expressing the transmission source information is stored in the transmission source image storage unit 71.

FIG. 5(d) is an illustration figure, showing an image composed by the image composition unit 73.

In FIG. 5(d), an image composed of, the image expressing the transmission destination information in FIG. 5(a), the first image expressing the transmission source information in FIG. 5(b), and the second image expressing the transmission source information in FIG. 5(c), is shown.

The transmission source shown in FIG. 5(d) and a composed image expressing a transmission destination in FIG. 5(d) are displayed on a transmission destination telephony device before an off-hook of a transmission destination telephony device.

How the telephony device 91 of FIG. 1 is constructed on a chip is exemplified.

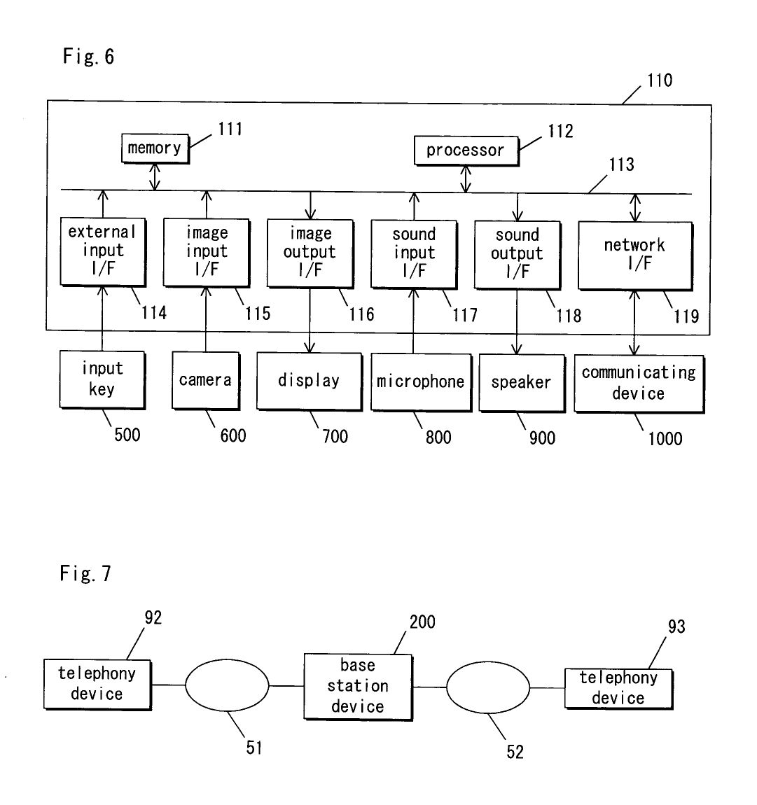

FIG. 6 is an illustration figure, showing a chip construction.

As shown in FIG. 6, a memory 110, a processor 112, a bus 113, an external input interface (external input I/F) 114, an image input interface (image input I/F) 115, an image output interface (image output I/F) 116, a sound input interface (sound input I/F) 117, a sound output interface (sound output I/F) 118, and a network interface (interface I/F) 119 are formed in this chip 110.

In the external input interface 114, information inputted from a key set 500 is inputted.

In the image input interface 115, an image signal inputted from a camera 600 is inputted.

In the image output interface 116, an image signal is outputted to a display 700.

In the sound input interface 117, sound signals inputted from a microphone 800 is inputted.

Sound signals are outputted to a speaker 900 from the sound output interface 118.

The network interface 119 performs input/output of information between a communicating device 1000 and itself.

The memory 111 functions as the units in FIG. 1: the transmission destination image storage unit 70, the transmission source image storage unit 71, the cutoff notice image storage unit 72, the sound storage unit 69 and the cutoff notice sound storage unit 79.

The processor 112 functions as the units in FIG. 1: the image composing unit 73, the image encoding unit 74, the multiplexing unit 76, the sound encoding unit 77, the switch units 75 and 78, the separation unit 82, the connection control unit 9 and the control unit 6.

The key set 500 is one example of the character input unit 2 of FIG. 1.

The camera 600 is one example of the image input unit 1 of FIG. 1.

The display 700 is one example of the image display unit 4 of FIG. 1.

The microphone 800 is one example of the sound input unit 3 of FIG. 1.

The speaker 900 is one example of the sound output unit 5 of FIG. 1.

In an example of FIG. 6, the memory 111 is an on-chip, but can be established in the outside of the chip 110 by attaching a memory interface on the chip 110.

As mentioned above, in the present embodiment, a transmission source telephony device transmits an image and sound expressing transmission source information to a transmission destination telephony device, before an off-hook of a transmission destination telephony device.

Because of this, in the transmission destination telephony device, the image expressing the transmission source information, which the transmission source telephony device transmits, can be displayed before an off-hook.

Because the transmission source telephony device transmits the image expressing the transmission source information (because registered information on a base station device in advance is not transmitted like formerly), a telephony device user of the transmission source can change a content of the image expressing the transmission source information if necessary, and can transmit based on a transmission destination.

In the transmission destination telephony device, sound expressing the transmission source information, which a telephony device of the transmission source, can be outputted before an off-hook.

The telephony device user of the transmission destination can make a decision regarding whether he/she wants to have communication or not more precisely before the user answers the phone.

In the present embodiment, a transmission source telephony device transmits an image expressing the transmission source information.

The degree of flexibility of expressing the transmission source information is larger as compared with the case where character information (character code) is transmitted.

Similarly, the degree of flexibility of expressing transmission destination information is larger.

In the present embodiment, a transmission source telephony device can transmit not only an image and sound expressing transmission source information, but also an image and sound expressing transmission destination information, before an off-hook of a transmission destination telephony device.

In the transmission destination telephony device, the image and the sound expressing the transmission destination information that the transmission source telephony device transmits be outputted can be displayed and outputted before an off-hook.

A telephony device user of the transmission source can determine if it is a wrong call or not before answering the call.

In the present embodiment, a user's face image of the transmission source telephony device can be included in an image expressing the transmission source information that the transmission source telephony device transmits.

In the transmission destination, recognition of the opponent (that is a transmission source) becomes even easier.

In the present embodiment, when a communication is refused, the transmission destination telephony device transmits a cutoff notice image and cutoff notice sound to the transmission source telephony device, and cuts off the communication with the transmission source telephony device after an off-hook.

As a result, the communication is cut off without having a conversation with the opponent (that is a transmission source), and as a cutoff notice image and cutoff notice sound, the reason for the cutoff can be notified to the transmission source.

As explained above, a composed image of, an image expressing transmission source information and an image expressing transmission destination information and sound expressing information of a transmission source/a transmission destination, can be transmitted to a transmission destination telephony device via the network 50.

Before an off-hook of the transmission destination telephony device, by transmitting at least an image expressing the transmission source information or sound expressing the transmission source information to the transmission destination telephony device, a telephony device user of a transmission destination can precisely determine if he/she wants to have a communication before answering the call.

On the above, it is explained that information, which the transmission source telephony device transmits before and off-hook, is an image.

The image is just one example of multimedia information, and the transmission source telephony device can transmit various multimedia information before an off-hook of the transmission destination telephony device.

Because of this, in the transmission destination telephony device, information, which is based on multimedia information that the transmission source telephony device transmits, can be displayed before an off-hook.

Because registered information on a base station device in advance is not transmitted, a telephony device user of the transmission source can change a content of the image expressing the transmission source information if necessary, and can transmit based on a transmission destination.

The telephony device user of the transmission destination can cope precisely before the user answers a call.

Still picture information, moving picture information, audio information, sound information, text information, a program, or a combination of these are the examples of “multimedia information” that is transmitted before an off-hook of a transmission destination telephony device.

JPEG (Joint Photographic Experts Group) data, GIF (Graphics Interchange Format) data, PNG (Portable Network Graphics) data, and raw RGB data that is not compressed are the examples of still picture information.

MPEG (Moving Pictures Experts Group) data is the example of moving picture information.

Data includes high sampling frequency, such as 32 kHz, 44.1 kHz, and 48 kHz, are the example of audio information.

Data contains sampling frequency, which is up to 20 kHz, is the example of sound information.

Regular text data, HTML (Hyper Text Markup Language) data, and XML (Extensible Markup Language) data are the examples of text information.

Java (a registered trademark) program is the example of a program.

A program is one kind of multimedia information because a program is able to generate, process, and compound still picture information, moving picture information, audio information, sound information, and text information.

Multimedia is generally a computer that compounds media such as images, sound, and characters, and unitarily treats. METHOD

### Second Embodiment

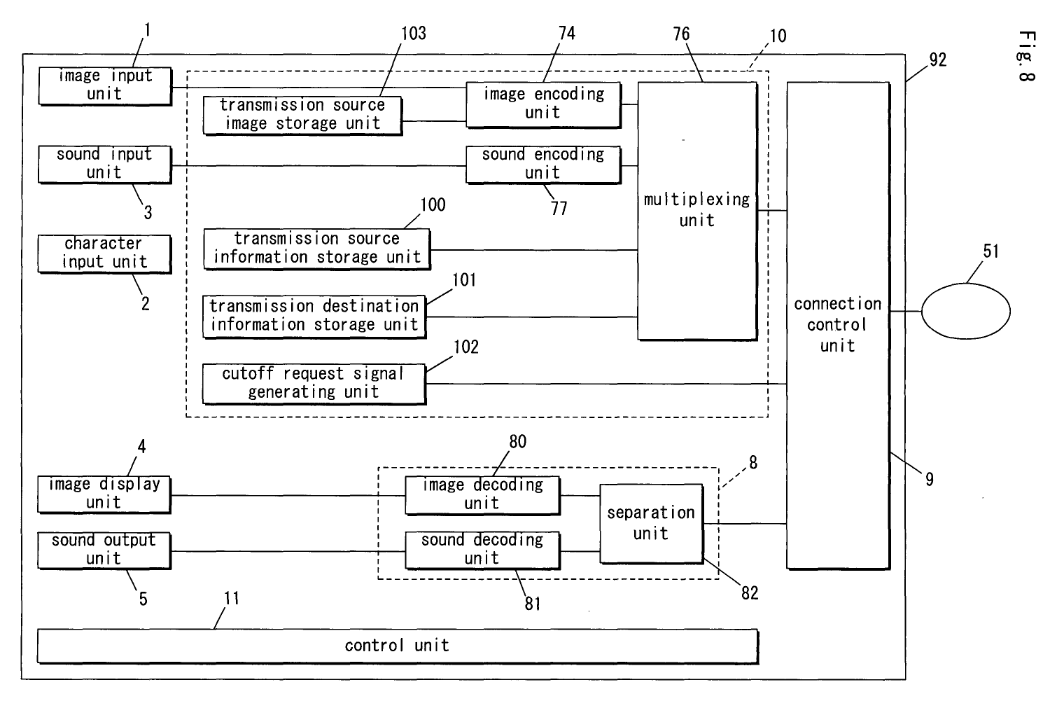

FIG. 8 is a block diagram, illustrating a communication system according to the first embodiment.

As shown in FIG. 7, this communication system comprises a telephony device 92, a telephony device 93 and a base station device 200.

The telephony device 92 is connected to the network 51.

The base station device 200 is connected to the networks 51 and 52.

The telephony device 93 is connected to the network 52.

The telephony device 92 and the telephony device 93 communicate each other via the base station device 200 and the networks 51 and 52.

A TV telephone device is the example of telephony devices 92 and 93.

These telephony devices include IP telephones.

FIG. 8 is a block diagram, illustrating the telephony device of FIG. 7.

In FIG. 8, the same units are labeled by the same symbols as in FIG. 1, and the explanation for these is omitted.

As shown in FIG. 8, this telephony device 92 establishes a transmission unit 10 instead of the transmission unit 7 of the telephony device 91 of FIG. 1, and also establishes a control unit 11 instead of the control unit 6 of the telephony device 91 of FIG. 1.

This transmission unit 10 includes a transmission source information storage unit 100, a transmission destination information storage unit 101, a cutoff request signal generating unit 102, a transmission source image storage unit 103, the image encoding unit 74, the multiplexing unit 76, and the sound encoding unit 77.

A construction of the telephony device 93 of FIG. 7 is as same as the construction of the telephony device 92 of FIG. 8.

Functions and operations for each construction is explained, mainly focusing on point differentiate from the first embodiment.

The control unit 11 controls each construction of the telephony device 92.

The transmission source image storage unit 103 of the transmission unit 10 stores an image signal expressing transmission source information.

A face image of a telephony device 92 user that is a transmission source is stored.

The image encoding unit 74 of the transmission unit 10 follows an instruction of the control unit 11, and encodes an image inputted from the image input unit 1 or an image read out from the transmission source image storage unit 103.

The transmission source information storage unit 100 of the transmission unit 10 stores transmission source information.

Information (character code) expressing a phone number of the telephony device 92 that is a transmission source is stored.

The transmission destination information storage unit 101 of the transmission unit 10 stores transmission destination information.

Information expressing a user name of a telephony device that can be a transmission destination from the telephony device and the phone number are stored.

When communication is refused, the cut off request signal generating unit 102 generates a cut off request signal.

The sound encoding unit 77 follows an instruction of the control unit 11, and encodes sound inputted from the sound input unit 3.

The multiplexing unit 76 follows an instruction of the control unit 11, and multiplexes an encoded image that the image encoding unit 74 encoded, information read out from the transmission source information storage unit 100, and information read out from the transmission destination information storage unit 101 before an off-hook of a transmission destination telephony device.

The multiplexing unit 76 follows an instruction of the control unit 11, and multiplexes an encoded image that the image encoding unit 74 encoded and encoded sound that the sound encoding unit 77 encoded after an off-hook of a transmission destination telephony device.

The connection control unit 9 follows an instruction of the control unit 11, and sends out a multiplexed signal multiplexed by the multiplexing unit 76 to the network 50.

The transmission destination information storage unit 101, the transmission source information storage unit 71, and the transmission source image storage unit 103 not only can be built in the telephony device 92, but also can be used after constructing as an external storage unit and then attaching to the telephony device 92.

Character information inputted in the character input unit 2 and character information inputted in the other character input unit can be used as the transmission source information that is stored in the transmission destination information storage unit.

Character information inputted in the character input unit 2 and character information inputted in the other character input unit can be used as the transmission source information that is stored in the transmission source information storage unit.

An image inputted in the image input unit 1 and an image inputted in the other image input unit can be used as information expressing the transmission source information that is stored in the transmission source image storage unit.

A flow of a transmission processing is explained.

In this case, the telephony device 92 is a transmission source (a transmitting side) and the telephony device 93 is a transmission destination (a receiving side).

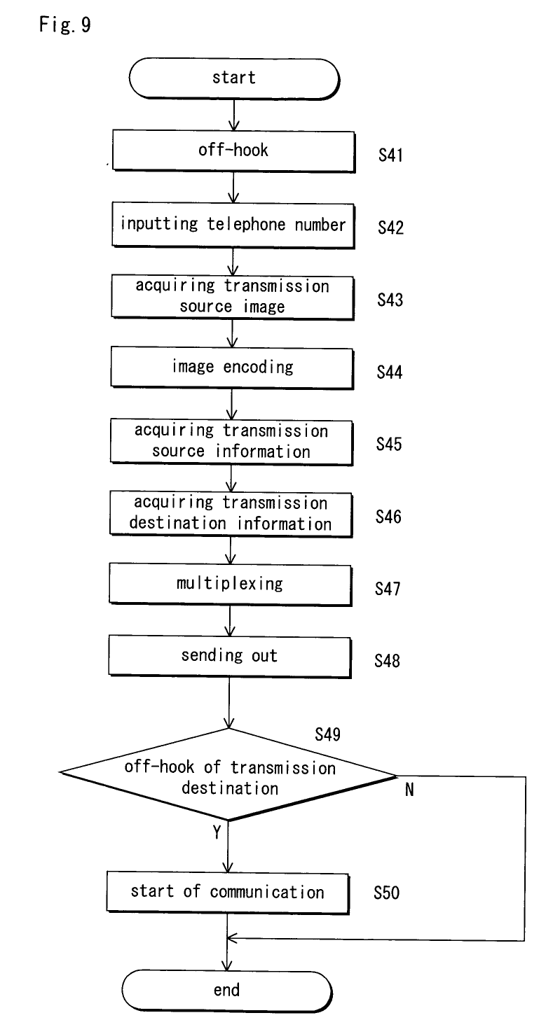

FIG. 9 is a flowchart, illustrating a transmission processing.

As shown FIG. 2, in step S41, the telephony device 92 (that is the transmission source) is hooked off.

In step S42, a phone number of the transmission destination is inputted from the character input unit 2.

In step S43, the image encoding unit 74 follows an instruction of the control unit 11, and acquires an image expressing the transmission source information either from the image input unit 1 or from the transmission source image storage unit 103.

In step S44, the image encoding unit 74 performs an encoding processing for an acquired image expressing the transmission source information.

In step S45, the multiplexing unit 76 follows an instruction of the control unit 11, and acquires the transmission source information from the transmission source information storage unit 100.

In step S46, the multiplexing unit 76 follows an instruction of the control unit 11, and acquires the transmission destination information from the transmission destination information storage unit 101.

In step S47, the multiplexing unit 76 follows an instruction of the control unit 11, multiplexes an encoded image expressing the transmission source information, the transmission source information, and the transmission destination information and then outputs as a multiplexed signal.

In step S48, the connection control unit 9 follows an instruction of the control unit 11, and sends out this multiplexed signal to the network 51.

As shown in FIG. 7, the base station device 200 connected to the network 51 performs a certain processing for this multiplexing signal, then this multiplexing signal is sent out to the network 52 as a different multiplexing signal. After this, the different multiplexing signal is transmitted to the telephony device 93 of the transmission destination.

A processing by the base station device 200 is explained in detail later.

Once again, it is returned to the explanation of FIG. 9.

In step S49, when the telephony device 93 of a transmission destination connected to the network 52 is hooked off, the communication can be started in step S50.

After this, the image encoding unit 74 follows an instruction of the control unit 11, and encodes an image inputted from the image input unit 1.

The sound encoding unit 77 follows an instruction of the control unit 77, and encodes sound inputted from the audio input unit 3.

The multiplexing unit 76 multiplexes an encoded image and encoded sound, and outputs it to the connection control unit 9 as a multiplexing signal.

The connection control unit 9 sends out a multiplexed signal to the network 51.

In step S49, when the transmission destination telephony device 93 is on-hook, communication will not be performed.

The processing order of step S43, S44, step 45, and step S46 is not limited as written here, but also a concurrent processing is possible.

An off-hook of step S41 is performed before the sending out of step S48, and is not limited to the order of FIG. 9.

A flow of reception processing is explained.

The telephony device 92 is assumed as a transmission destination (a receiving side).

The flow of the reception processing of the telephony device 92 is similar to the reception processing of the first embodiment as shown in FIG. 3.

A cutoff processing is different from the processing in step S29 of the first embodiment as shown in FIG. 3.

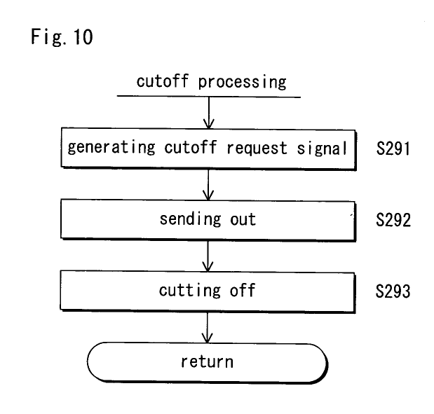

FIG. 10 is a flowchart, illustrating a cutoff processing in the second embodiment.

In step S291, as shown in FIG. 10, the cutoff request signal generating unit 102, follows an instruction of a control unit 11, and generates a cutoff request signal and outputs to the connection control unit 9.

In step S292, the telephony device 92 is hooked off, and the connection control unit 9 sends out the cutoff request signal to the network 51.

The base station device 200 receives the cutoff request signal and transmits a cutoff notice image and cutoff notice sound to the transmission source telephony device.

This point is explained in detail later.

In the transmission source telephony device, a telephony device user of the transmission source can understand a reason for the cutoff since the cutoff notice image and the cutoff notice sound are outputted.

In step S293, the telephony device 92 is hooked on, and communication is interrupted.

The base station device 200 of FIG. 7 is explained.

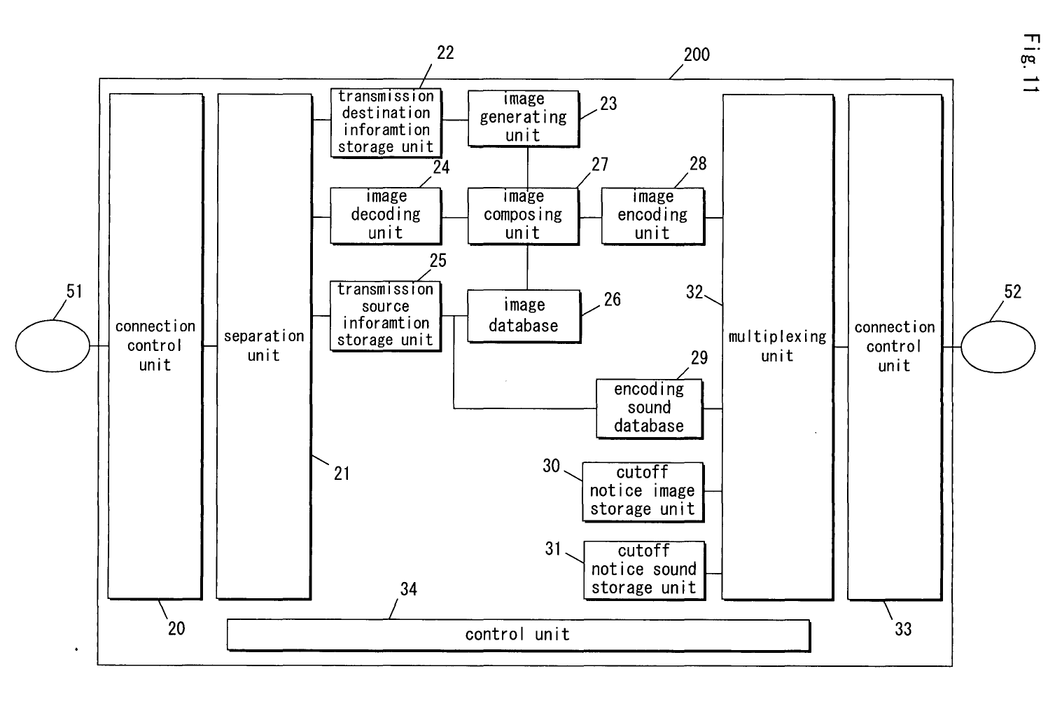

FIG. 11 is a block diagram showing the base station device 200 of FIG. 7.

As shown in FIG. 1, the base station device 200 comprises a connection control unit 20, a separation unit 21, a transmission destination information storage unit 22, an image generating unit 23, an image decoding unit 24, a transmission source information storage unit 25, an image database 26, an image composing unit 27, an image encoding unit 28, an encoding sound database 29, a cutoff notice image storage unit 30, a cutoff notice sound storage unit 31, a multiplexing unit 32, a connection control unit 33, and a control unit 34.

Functions and operations of each construction are explained.

When the received signal is the multiplexed signal which is generated by the multiplexing unit 76 of FIG. 8, the connection control unit 20 follows an instruction of the control unit 34, and provides the separating unit 21 the received multiplexed signal.

When the received signal is a cutoff request signal which is generated by the cutoff request signal generating unit 102 of FIG. 8, the connection control unit 20 outputs the signal to the control unit 34.

The separating unit 21 follows an instruction of the control unit 34, and separates a multiplexed signal provided from the connection control unit 20 into an image expressing information of an encoded transmission source, the transmission source information, and the transmission destination information.

The transmission destination information storage unit 22 follows an instruction of the control unit 34, and stores the transmission destination information which is separated by the separating unit 21.

The image generating unit 23 follows an instruction of the control unit 34, and generates an image based on the transmission destination information which is stored in the transmission destination information storage unit 22.

When the transmission destination information is information expressing a full name of a user of the transmission destination telephony device (a character code), an image expressing the full name of the transmission destination telephony device user is generated (for example, an image named “Mr./Ms. ∘∘”)

The image decoding unit 24 follows an instruction of the control unit 34, and decodes an image expressing and the encoded transmission source information separated by the separating unit 21.

When an image expressing the transmission source information is a face image of a telephony device user of the transmission source, the concerned encoded face image is decoded.

In the image database 26, the transmission source information and an image expressing the transmission source information are correlated each other and stored therein.

This transmission source information is the information corresponding to the transmission source information stored in the transmission source information storage unit 25.

When the transmission source information stored in the transmission source information storage unit 25 is a telephone number of a telephony device of the transmission source, the telephone number of the transmission source telephony device and an image expressing the transmission source information are correlated each other and stored in the image database 26.

As an image expressing the transmission source information, there are examples such as an image expressing a name of the telephony device user of the transmission source (for example, “This is ∘.”), and an image expressing a telephone number of the transmission source telephony device (for example, “∘∘∘-∘∘∘-∘∘∘∘”).

Such image database 26 follows an instruction of the control unit 34, and searches an image expressing the transmission source information corresponding to the transmission source information stored in the transmission source information storage unit 25.

The image composing unit 27 follows an instruction of the control unit 34, and acquires an image expressing transmission source information corresponding to the transmission source information stored in the transmission source information storage unit 25.

The image composing unit 27 follows an instruction of the control unit 34, and acquires an image expressing the transmission destination information.

The image composing unit 27 follows an instruction of the control unit 34, and acquires an image expressing the transmission source information decoded by the image decoding unit 24.

The image composing unit 27 follows an instruction of the control unit 34, and composes of an image expressing the transmission destination information acquired from the image generating unit 23 and an image expressing the transmission source information acquired from the image decoding unit 24, and an image expressing the transmission source information acquired from the image database 26, and generates a composed image.

The image encoding unit 28 follows an instruction of the control unit 34, and performs encoding the composed image generated by the image composing unit 27.

In the encoding sound database 29, the transmission source information and sound expressing the encoded the transmission source information are correlated each other and stored therein.

This transmission source information is information corresponding to the transmission source information stored in the transmission source information storage unit 25.

When the transmission source information stored in the transmission source information storage unit 25 is a telephone number of the transmission source telephony device, the telephone number of the transmission source telephony device and the sound expressing the transmission source information are correlated each other and stored in the encoding sound database 29.

The sound expressing the transmission source information is, for example, sound expressing a name of a telephony device user of the transmission source.

Such encoding sound database 29 follows an instruction of the control unit 34, and searches the sound expressing the transmission source information corresponding to the transmission source information stored in the transmission source information storage unit 25.

The already encoded sound being stored in the encoding sound database 29, a function for encoding the sound expressing the becomes unnecessary, and searches the sound expressing the transmission source information.

When a transmission destination (a receiving side) refuses a communication, the cutoff notice image storage unit 30 stores an image for notifying the refusal (the image is referred to a “cutoff notice image” as follows).

The cutoff notice image storage unit 30 stores a cutoff notice image, which is “You've got a wrong number. The telephone number this place is ∘∘∘.”

In the present embodiment, the cutoff notice image storage unit 30 is assumed to store an encoded cutoff notice image.

A function for encoding the encoded cutoff notice image is unnecessary, and can be simplified.

When a communication is refused, the cutoff notice sound storage unit 31 stores sound for notifying the refusal (the sound is referred to “cutoff notice sound” as follows).

The cutoff notice sound storage unit 31 stores the cutoff notice sound, which is “You've got a wrong number. The telephone number this place is ∘∘∘.”

In the present embodiment, the cutoff notice sound storage unit 31 is assumed to store encoded cutoff notice sound.

A function for encoding the encoded cutoff notice sound is unnecessary, and can be simplified.

The multiplexing unit 32 follows an instruction of the control unit 34, and multiplexes a composed image encoded by the image encoding unit 28 and sound expressing transmission source information acquired from the encoding sound database 29, and generates a multiplexed signal.

The multiplexing unit 32 follows an instruction of the control unit 34 that received a cutoff request signal, and multiplexes the cutoff notice image stored in the cutoff notice image storage unit 30 and the cutoff notice sound stored in the cutoff notice sound storage unit 31, and generates a multiplexed signal.

The connection control unit 33 sends out the multiplexed signal generated by the multiplexing unit 32 to a network 52.

When the telephony device connected to the network 51 and the telephony device connected to the network 52 are both hooked off and start a communication, a signal received from the network 51 by the connection control unit 20 is outputted to the connection control unit 33. The connection control unit 33 outputs the input signal to the network 52.

The signal received from the network 52 by the connection control unit 33 is outputted to the connection control unit 20. The connection control unit 20 outputs the input signal to the network 51.

A flow of processing according to the base station device 200 is now described using a flowchart.

A processing prior to start of a communication (in step S47 of FIG. 9, a multiplexed signal processing generated by the multiplexing unit 76 of FIG. 8) is now described.

An image expressing transmission source information, transmission source information, and the transmission destination information are multiplexed for the above described multiplexed signal.

A telephony device 92 is assumed to be a transmission source, and a telephony device 93 is assumed to be a transmission destination.

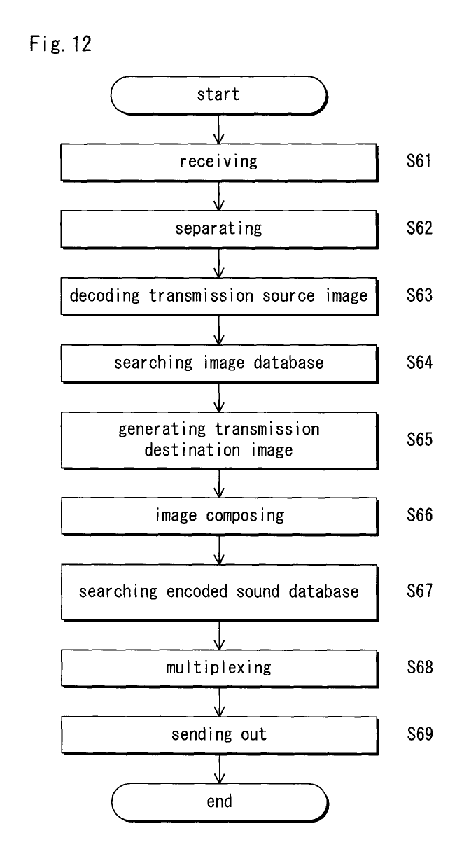

FIG. 12 is a flowchart, illustrating a processing in the base station 200 before start of a communication.

As shown in FIG. 12, in step S61, the connection control unit 20 receives a multiplexed signal transmitted by the telephony device 92 of the transmission source from the network 51, and outputs to the separation unit 21 following an instruction of the control unit 34.

In step S62, the separation unit 21 follows an instruction of the control unit 34, and separates the input multiplexed signal into the transmission destination information, into an image expressing encoded transmission source information, and into transmission source information.

The above transmission destination information is given to the transmission destination information storage unit 22 and stored.

The above image expressing the encoded transmission source information is given to the image decoding unit 24.

The above transmission source information is given to the transmission source information storage unit 25.

In step S63, the image decoding unit 24 follows an instruction of the control unit 34, and performs a decoding processing to an image expressing encoded transmission source information.

In step S64, the image database 26 follows an instruction of the control unit 34, and searches information expressing transmission source information corresponding to the transmission source information stored in the transmission source information storage unit 25.

In step S65, the image generating unit 23 follows an instruction of the control unit 34, and generates an image expressing the transmission destination information based on the transmission destination information stored in the transmission destination information storage unit 22.

In step S66, the image composing unit 27 follows an instruction of the control unit 34, and composes of an image expressing transmission source information searched by the image database 26, of an image expressing transmission source information decoded by the image decoding unit 24, and of an image expressing the transmission destination information generated by the image generating unit 23, and generates a composed image.

In step S67, the encoding sound database 29 follows an instruction of the control unit 34, and searches sound expressing the encoded transmission source information corresponding to the transmission source information stored in the transmission source information storage unit 25.

In step S68, the multiplexing unit 32 follows an instruction of the control unit 34, and multiplexes the composed image encoded by the image encoding unit 28 and the sound searched by the encoding sound database 29, and generates a multiplexed signal.

In step S69, the connection control unit 33 follows an instruction of the control unit 34, and sends out a multiplexed signal to the network 52.

The base station device 200 performs the processing prior to the start of the communication as described above.

In the transmission destination telephony device 93, before an off-hook, an image expressing the transmission destination information and the transmission source can be displayed, and sound expressing transmission source information can be outputted.

When the transmission destination telephony device 93 is hooked off, a communication can be performed between the telephony device 92 and the telephony device 93 via the base station device 200.

The processing order of step S63, step S64, and step S65 of FIG. 12 is not limited as written here, but also a concurrent processing is possible.

The processing order of step S63 through step S66 and step S67 of FIG. 12 is not limited as written here, but also a concurrent processing is possible.

A flow of a processing when the base station device 200 receives a cutoff request signal is now explained.

The telephony device 93 is assumed to make a phone call to the telephony device 92, and the telephony device 92 is assumed to transmit the cutoff request signal to the base station device 200.

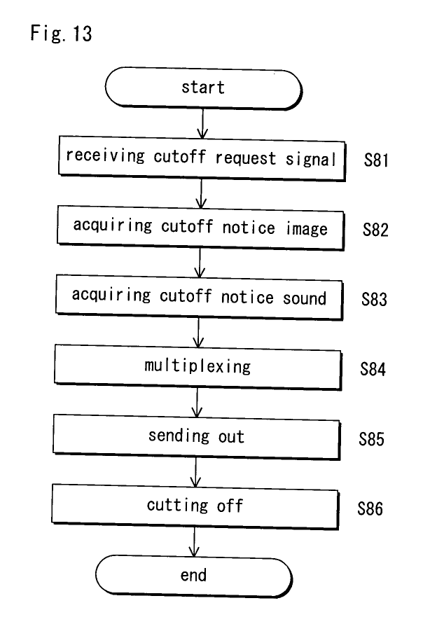

FIG. 13 is a flowchart, illustrating a cutoff processing according to the base station device 200.

As shown in FIG. 13, in the step S81, the connection control unit 20 receives the cutoff request signal transmitted by the telephony device 92 from the network 51, and gives the cutoff request signal to the control unit 34.

In step S82, the multiplexing unit 32 follows an instruction of the control unit 34 that received the cutoff request signal, and acquires a cutoff notice image from the cutoff notice image storage unit 30.

In step S83, the multiplexing unit 32 follows an instruction of the control unit 34 that received the cutoff request signal, and acquires cutoff notice sound from the cutoff notice sound storage unit 31.

In step S84, the multiplexing unit 32 follows an instruction of the control unit 34, multiplexes a cutoff notice image and cutoff notice sound, and generates a multiplexed signal.

In step S85, the connection control unit 33 sends out the multiplexed signal to the network 52.

In the telephony device 93 which received the multiplexed signal, a cutoff notice image can be displayed and cutoff notice sound can be outputted; therefore, a user of the telephony device 93 can understand a reason for the cutoff.

In step S86, the control unit 34 cuts off a communication between the telephony device 92 and the telephony device 93.

The processing order of step S82 and step S83 of FIG. 13 is not limited as written here, but also a concurrent processing is possible.

How the telephony device 92 of FIG. 8 is constructed on a chip is exemplified using FIG. 6.

The memory 111 functions as the transmission destination information storage unit 101, the transmission source information image storage unit 100, and the transmission source image storage unit 103.

The processor 112 functions as the image encoding unit 74, the multiplexing unit 76, the sound encoding unit 77, the cutoff request signal generating unit 102, the image decoding unit 80, the sound decoding unit 81, the separation unit 82, the connection control unit 9, and the control unit11 of FIG. 8.

The key set 500 is one example of the character input unit 2 of FIG. 8.

The camera 600 is one example of the image input unit 1 of FIG. 8.

The display 700 is one example of the image display unit 4 of FIG. 8.

The microphone 800 is one example of the sound input unit 3 of FIG. 8.

The speaker 900 is one example of the sound output unit 5 of FIG. 8.

As mentioned above, in the present embodiment, the transmission source telephony device transmits transmission source information to the base station device 200 before an off-hook of the transmission destination telephony device.

The base station device 200 acquires an image and sound based on the transmission source information which is transmitted by the transmission source telephony device, and transmits the acquired image and sound to the transmission destination telephony device before the off-hook of the transmission destination telephony device.

In the transmission destination telephony device, the acquired image by the base station device 200 can be displayed before the off-hook based on the transmission source information which is transmitted by the transmission source telephony device.

Because the transmission source telephony device transmits the transmission source information (because registered information on a base station device in advance is not transmitted like formerly), a telephony device user of the transmission source can change a content of the transmission source information if necessary, and can transmit based on a transmission destination.

In the transmission destination telephony device, the acquired sound by the base station device 200 can be outputted before the off-hook based on the transmission source information which is transmitted by the transmission source telephony device.

As a result, the user of the transmission destination telephony device can make a decision regarding whether he/she wants to have communication or not more precisely before user answers the phone.

In the present embodiment, an image expressing transmission source information is finally transmitted to the transmission destination telephony device; therefore the degree of flexibility of the transmission source information is large compared to a case when character information is transmitted.

For the same reason, degree of expression of the transmission destination is also large.

In the present embodiment, the transmission source telephony device can also transmit the transmission destination information before an off-hook of the transmission destination telephony device in addition to transmission source information.

The transmission destination information is transmitted from the transmission source telephony device to the base station device 200, and is transmitted to the transmission destination telephony device of as an image.

In the transmission destination telephony device, the image expressing the transmission destination information can be displayed before the off-hook. The transmission destination information is transmitted from the transmission source.

The user of the transmission destination telephony device can determine if it is a wrong call or not before the user answers the phone.

In the present embodiment, the base station device 200 transmits a cutoff notice image and cutoff notice sound to a telephony device of the transmission source based on the cutoff request signal transmitted by the transmission destination telephony device after an off-hook, and cuts off communication of the transmission source telephony device and the transmission destination telephony device.

As a result, a conversation is cutoff without having conversation with the opponent (that is a transmission source), and the reason for the cutoff can be informed of the transmission source as the cutoff notice image and the cutoff notice sound.

In the present embodiment, in an image expressing transmission source information transmitted by the transmission source telephony device, a face image of a telephony device user of the transmission source can be included.

As a result, in the transmission destination, the opponent of the transmission source is easily recognized.

In the present embodiment, an image expressing transmission source information is accumulated in the image data base 26 of the base station device 200. The image data base 26 limits less storage capacity compared to the telephony device.

As a result, a user can accumulate the image expressing various transmission source information in the image data base 26, and can perform improvement of convenience.

The user can accumulate sound expressing various transmission source information in the encoding sound database 29, and can perform improvement of convenience.

In the present embodiment, an image and sound expressing the transmission destination information and the transmission source are acquired in the base station device 200.

Compared with the telephony device 91 of the first embodiment, simplification of the telephony device 92, reduction of memory capacity, and speedup of a processing are performed.

In the telephony device 92, the image composing unit 73 and the sound storage unit 69 of FIG. 1 are unnecessary.

As described above, the transmission destination information, the transmission source information, and the image expressing the transmission source information are performed.

By transmitting at least the image expressing the transmission source information or the transmission destination information to the base station device 200 before an off-hook of the transmission destination telephony device, a user of the transmission destination telephony device can make a decision whether he/she wants to have communication or not precisely before the user answers the phone.

As described above, the transmission source image storage unit 103 is provided in the telephony device 92.

For reduction of memory capacity of the telephony device 92, the transmission source image storage unit 103 can be removed, and information stored in the transmission source image storage unit 103 (for example, a face image of a user of the telephony device 92) can also be stored in the image database 26 of the base station device 200.

As described above, the image database 26 is provided in the base station device 200 of FIG. 11.

Instead of the image database 26, an image generating unit which generates an image based on transmission source information can also be provided.

### Third Embodiment

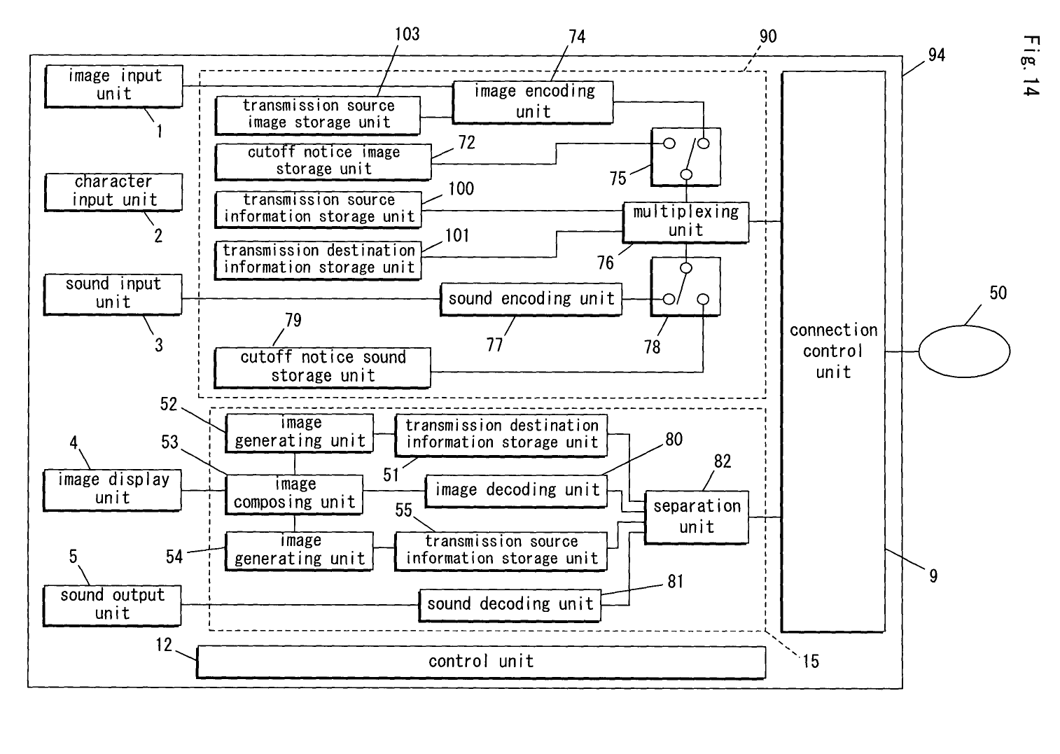

FIG. 14 is a block diagram illustrating a telephony device of the present embodiment.

In FIG. 14, the same units or devices are labeled by the same symbols as in FIG. 1, and the explanation for these is omitted.

In FIG. 14, the similar units or devices are labeled by the same symbols as in FIG. 8, and the explanation for these is omitted.

As shown in FIG. 14, a telephony device 94 of the present embodiment establishes a transmitting unit 90 instead of the transmitting unit 7 of FIG. 1, establishes a control unit 12 instead of the control unit 6 of FIG. 1, and establishes a receiving unit 15 instead of the receiving unit 8 of FIG. 1.

The transmitting unit 90 includes the transmission source image storage unit 103, the transmission source information image storage unit 100, the transmission destination information storage unit 101, the cutoff notice image storage unit 72, the image encoding unit 74, the switch unit 75, the multiplexing unit 76, the sound encoding unit 77, the switch unit 78, and the cutoff notice sound storage unit 79.

The receiving unit 15 includes the image generating unit 52, the image composing unit 53, the image generating unit 54, the transmission destination information storage unit 51, the image decoding unit 80, the transmission source information storage unit 55, the sound decoding unit 81, and the separation unit 82.

The telephony device 94 is, for example, a TV telephone device.

The telephone device 94 includes an IP telephone.

Functions and operations of each construction are explained mainly on different points from that of the telephony device 91 of FIG. 1 and the telephony device 92 of FIG. 8.

The control unit 12 controls each construction of the telephony device of FIG. 14.

The transmitting unit 90 is now explained.

The transmission source image storage unit 103 stores an image signal expressing transmission source information.

The image encoding unit 74 follows an instruction of the control unit 12, and performs encoding an image inputted from the image input unit 1 or an image read out from the transmission source image storage unit 103.

The cutoff notice image storage unit 72 stores the encoded cutoff notice image.

The switch unit 75 follows an instruction of the control unit 12, and outputs either an encoded image generated by the encoding unit 74 or the cutoff notice image read out from the cutoff notice image storage unit 72 to the multiplexing unit 76.

The transmission source information storage unit 100 stores transmission source information.

The transmission destination information storage unit 101 stores the transmission destination information.

The sound encoding unit 77 follows an instruction of the control unit 12, and encodes sound inputted form the sound input unit 3.

The cutoff notice sound storage unit 79 stores the encoded cutoff notice sound.

The switch unit 78 follows an instruction of the control unit 12, and outputs either the encoded sound generated by the encoding unit 77 or the cutoff notice sound read out by from the cutoff notice sound storage unit 79 to the multiplexing unit 76.

The multiplexing unit 76 follows an instruction of the control unit 12, and multiplexes the encoded image encoded by the image encoding unit 74, the information read out from the transmission source information image storage unit 100, and the information read out from the transmission destination information storage unit 101 before an off-hook of the transmission destination telephony device.

The multiplexing unit 76 follows the instruction of the control unit 12, and multiplexes the encoded image encoded by the image encoding unit 74 and the encoded sound encoded by the sound encoding unit 77 after the off-hook of the transmission destination telephony device.

When an instruction of communication refusal from the control unit 12, the multiplexing unit 76 multiplexes the cutoff notice image read out from the cutoff notice image storage unit 72 and the cutoff notice sound read out from the cutoff notice sound storage unit 79.

The connection control unit 9 follows an instruction of the control unit 12, and sends out a multiplexed signal by the multiplexing unit 76 to the network 50.

The transmission destination information storage unit 101, the transmission source information image storage unit 100, the transmission source image storage unit 103, the cutoff notice image storage unit 72, and the cutoff notice sound storage unit 79 not only can be built in the telephony device 94, but also can be used after constructing as an external storage unit and then attaching to the telephony device 94.

The receiving unit 15 is now explained.

The separation unit 82 follows an instruction of the control unit 12, and separates the multiplexed signal provided from the connection control unit 9.

While a communication is carried out (after an off-hook of the telephony device 94) the multiplexed signal received by the connection control unit 9 is a multiplexed signal of an encoded image and encoded sound, in this case, the separation unit 82 separates the multiplexed signal into the encoded image and the encoded sound, provides the encoded image to the image decoding unit 80, and provides the encoded sound to the sound decoding unit 81.

Before start of a communication (before an off-hook of the telephony device 94), the connection control unit 9 is a multiplexed signal of the transmission destination information, transmission source information, an image expressing encoded transmission source information, and sound expressing encoded information of a transmission source/a transmission destination. In this case, the separation unit 82 separates the multiplexed signal into the transmission destination information, the transmission source information, the image expressing the encoded transmission source information, and the sound expressing the encoded information of a transmission source/a transmission destination, provides the image expressing the encoded transmission source information to the image decoding unit 80, provides the transmission source information to the transmission source information storage unit 55, provides the transmission destination information to the transmission destination information storage unit 51, and provides the sound expressing the encoded information of a transmission source/a transmission destination to the sound decoding unit 81.

The transmission destination information is, for example, information expressing a telephone number and a name of a telephony device user of the transmission destination (a character code).

The transmission source information is, for example, information expressing a telephone number and a name of a telephony device user of the transmission source (a character code).

The image expressing the encoded transmission source information is, for example, a face image of a telephony device user of the transmission source.

The sound expressing the information of the transmission source/the transmission destination is, for example, sound expressing a name of a telephony device user of the transmission source, sound expressing a name of a telephony device user of the transmission destination, or sound expressing a name of a telephony device user of the transmission source and a name of a telephony device user of the transmission destination.

The transmission destination information storage unit 51 follows an instruction of the control unit 12, and stores the transmission destination information separated by the separation unit 82.

The image decoding unit 80 follows an instruction of the control unit 12, and performs a decoding processing to the image expressing the encoded transmission source information separated by the separation unit 82 or the encoded image during the communication separated by the separation unit 82.

When an object of decoding is an image expressing transmission source information, the image decoding unit 80 follows the instruction of the control unit 12, and provides the decoded image to the image composing unit 53. When the object of decoding is an image during a communication, the image decoding unit 80 provides the decoded image to the image display unit 4.

The transmission source information storage unit 55 follows an instruction of the control unit 12, and stores transmission source information separated by the separation unit 82.

The image generating unit 52 follows an instruction of the control unit 12, and generates an image expressing the transmission destination information based on information stored in the image generating unit 52.

When the transmission destination information stored in the transmission destination information storage unit 51 is information expressing a telephone number and a name of the transmission destination, an image expressing the telephone number and the name of the transmission destination is generated.

The image generating unit 54 follows an instruction of the control unit 12, and generates an image expressing transmission source information based on the transmission source information stored in the transmission source information storage unit 55.

When the transmission source information stored in the transmission source information storage unit 55 is information expressing a telephone number and a name of the transmission source (a character code), an image expressing the telephone number and the name of the transmission source is generated.

The image composing unit 53 follows an instruction of the control unit 12, and composes the image expressing the transmission destination information generate by the image generating unit 52 (for example, an image expressing a telephone number and a name of the telephony device user of the transmission destination), the image expressing the transmission source information generated by the image generating unit 54 (for example, the image expressing the telephone number and the name of the telephony device user of the transmission source), and the image expressing the transmission source information decoded by the image decoding unit 80 (for example, a face image of the telephony device user of the transmission source). The composed image is generated and provided to the image display unit 4.

The sound decoding unit 81 follows an instruction of the control unit 12, and performs a decoding processing to sound expressing encoded information of a transmission source/a transmission destination or encoded sound during a communication. The decoded sound is provided to the sound output unit 5.

A flow of the entire processing is now described using a flowchart.

A transmission processing is explained.

The telephony device 94 is assumed as a transmission source (a transmitting side).

The processing in this case is similar to the transmission processing shown in FIG. 9.

A reception processing is explained.

The telephony device 94 is assumed to be a transmission destination (a receiving side)

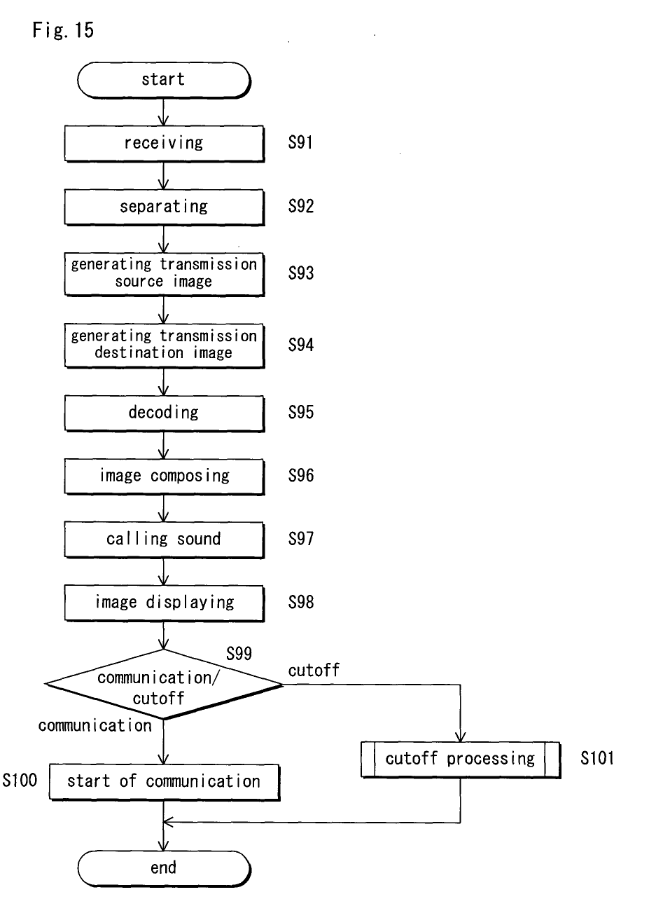

FIG. 15 is a flowchart, illustrating a reception processing.

As shown in FIG. 15, in step S91, the connection control unit 9 receives a multiplexed signal transmitted from a telephony device (that is a transmission source) that is connected to the network 50.

This multiplexed signal is a signal multiplexed an image expressing encoded transmission source information, transmission source information, and the transmission destination information.

In step S92, the separation unit 82 follows an instruction of the control unit 12, and separates multiplexed signal into encoded transmission source information, transmission source information, the transmission destination information.

In step S93, the image generating unit 54 follows an instruction of the control unit 12, and generates an image expressing transmission source information, based on transmission source information that is stored in the transmission source information storage unit 55.

In step S94, the image generating unit 52 follows an instruction of the control unit 12, and generates an image expressing the transmission destination information, based on the transmission destination information that is stored in the transmission destination information storage unit 51.

In step S95, the image decoding unit 80 follows an instruction of the control unit 12, and decodes an encoded image expressing transmission source information that the separation unit 82 separated.

In step S96, the image composing unit 53, in accordance with an instruction of the control unit 12, composes an image expressing the transmission destination information that the image generating unit 52 generated, an image expressing transmission source information that the image generating unit 54 generated, and an image expressing transmission source information that the image decoding unit 80 decoded, and generates a composed image.

In step S97, in accordance with an instruction of the control unit 12, calling sound is made.

In step S98, the image display unit 4 follows an instruction of the control unit 12, and displays the composed image that the image composing unit 53 generated.

In step S99, when the telephony device 94 (that is the transmission destination) is hooked off and the control unit 12 gives an instruction of start of a communication, the communication can be started in step S100.

After this, an image, which the transmission source telephony device connected to the network 50 transmits, is displayed on the image display unit 4 via the connection control unit 9, the separation unit 82, and the image decoding unit 80. Sound, which a telephony device of the transmission source connected to the network 50 transmits, is outputted from the sound output unit 5 via the connection control unit 9, the separation unit 82, and the sound decoding unit 81.

In step S99, when an instruction of a cutoff is given by the control unit 12, a cutoff processing is performed in step S101.

Thiscutoff processing is similar to the cutoff processing as shown in FIG. 4.

The processing order of step S93, step S94 and step S95 is not limited as written here, but a concurrent processing is also possible.

Calling sound can be made not only after step S96 in FIG. 15, but can be also made after receiving.

How the telephony device 94 in FIG. 14 is constructed on a chip is exemplified by using FIG. 6.

The memory 111 functions as the units in FIG. 14: the transmission destination information storage unit 101, the transmission source information storage unit 100, the transmission source image storage unit 103, the cutoff notice image storage unit 72, the cutoff notice sound storage unit 79, the transmission destination information storage unit 51, and the transmission source storage unit 55[0524]

The processor 112 functions as the units in FIG. 14: the image encoding unit 74, the switch unit 75, the multiplexing unit 76, the sound encoding unit 7, the switch unit 78, the image generating units 52 and 54, the image decoding unit 80, the sound decoding unit 81, the image composing unit 53, the separation unit 82, the connection control unit 9, and the control unit 12.

The key set 500 is one example of the character input unit 2 of FIG. 14.

The camera 600 is one example of the image input unit 1 of FIG. 14.

The display 700 is one example of the image display unit 4 of FIG. 14.

The microphone 800 is one example of the sound input unit 3 of FIG. 14.

The speaker 900 is one example of the sound output unit 5 of FIG. 14.

As mentioned above, in the present embodiment, the transmission destination telephony device generates the image based on the transmission source information transmitted by the transmission source telephony device, and displays the concerned image before the off-hook.

In the transmission destination telephony device, the image generated based on the transmission source information transmitted by the transmission source telephony device can be displayed before the off-hook.

Because the transmission source telephony device transmits transmission source information (because registered information on a base station device in advance is not transmitted formerly), a telephony device user of the transmission source can change a content of the transmission source information if necessary, and can transmit based on the transmission destination.

As a result, the telephony device user of the transmission destination can make a decision regarding whether he/she wants to have communication or not more precisely before the user answers the phone.

In the present embodiment, in the transmission destination telephony device, the image is generated based on the transmission destination information transmitted by the transmission source telephony device, and the concerned image can be displayed before the off-hook.

As a result, this telephony device user of the transmission destination can determine if it is a wrong call or not before the user answers the phone.

In the present embodiment, when the transmission destination telephony device refuses a communication, the telephony device transmits a cutoff notice image and cutoff notice sound to the transmission source telephony device, and cuts off the communication with the transmission source telephony device.

As a result, the conversation is cutoff without having conversation with the opponent (that is the transmission source), and a reason for the cutoff can be informed of the transmission source as the cutoff notice image and the cutoff notice sound.

As described above, the transmission destination information and the transmission source information are transmitted to the transmission destination telephony device via the network 50.

By transmitting at least the image expressing transmission source information to the transmission destination telephony device, the telephony device user of the transmission destination can make a decision whether he/she wants to have communication or not precisely before the user answers the phone.

A combination of the first embodiment and the second embodiment, a combination of the first embodiment and the third embodiment, or a combination of the second embodiment and the third embodiment are possible. Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A telephony device comprising
a transmission unit operable to transmit multimedia information to a transmission destination telephony device before the transmission destination telephony device is in an off-hook state.

2. A telephony device comprising
an image display unit operable to display, before an off-hook state, information based on multimedia information transmitted by a transmission source telephony device.

3. A telephony device comprising
a transmission unit operable to transmit, before a transmission source telephony device is in an off-hook state, image expressing transmission source information.

4. The telephony device of claim 3
wherein said transmission unit transmits, before a transmission destination telephony device is in an off-hook state, image expressing transmission destination information to the transmission destination telephony device.

5. A telephony device for transmitting an image based on received information to a transmission destination telephony device via a base station device to communicate with the transmission destination telephony device, said telephony device comprising
a transmission unit operable to transmit, before the transmission destination telephony device is in an off-hook state, transmission source information to the base station device,
wherein the base station device acquires said image based on the received information.

6. The telephony device of claim 5
wherein said transmission unit is operable to transmit, before the transmission destination telephony device is in the off-hook state, transmission destination information to the base station device, and
wherein the base station device acquires, according to the transmission destination information, the image based on the received information.

7. A telephony device comprising
an image display unit operable to display, before an off-hook state, image expressing transmission source information transmitted by a transmission source telephony device.

8. The telephony device of claim 7,
wherein said image display unit displays, before the off-hook state, image expressing transmission destination information transmitted by the transmission source telephony device.

9. A telephony device comprising
an image display unit operable to display, before an off-hook state, an image acquired by a base station device relaying communications between a transmission source telephony device and said telephony device,
wherein the base station acquires the image based on transmission source information.

10. The telephony device of claim 9,
wherein said image display unit is operable to display, before the off-hook state, an image that has been acquired based on transmission destination information transmitted by the transmission source telephony device.

11. A telephony device comprising:
a first image generating unit operable to generate an image based on transmission source information transmitted by a transmission source telephony device; and
an image display unit operable to display the image before said image display unit is in an off-hook state.

12. The telephony device of claim 11, further comprising
a second image generating unit operable to generate an image based on transmission destination information transmitted by the transmission source telephony device,
wherein said image display unit is operable to display, before the off-hook state, the image generated by said second image generating unit.

13. The telephony device of claim 3,
wherein the image expressing the transmission source information comprises a face image.

14. The telephony device of claim 5,
wherein the image based on the received information comprises a face image.

15. The telephony device of claim 7,
wherein the image expressing the transmission source information comprises a face image.

16. The telephony device of claim 9,
wherein the image based on the transmission source information comprises a face image.

17. A telephony device comprising
a transmission unit operable to transmit, before a transmission destination telephony device is in an off-hook state, sound signals expressing transmission source information.

18. The telephony device of claim 17,
wherein said transmission unit is operable to transmit, before the off-hook state, sound signals expressing transmission destination information.

19. The telephony device of claim 7, further comprising
a connection control unit operable to transmit, after the off-hook state, a predetermined image to the transmission source telephony device to cutoff communications between the transmission source telephony device and said telephony device.

20. The telephony device of claim 11, further comprising
a connection control unit operable to transmit, after the off-hook state, a predetermined image to the transmission source telephony device to cutoff communications between the transmission source telephony device and said telephony device.

21. The telephony device of claim 7, further comprising
a connection control unit operable to transmit, after the off-hook state, predetermined sound signals to the transmission source telephony device to cutoff communications between the transmission source telephony device and said telephony device.

22. The telephony device of claim 11, further comprising
a connection control unit operable to transmit, after the off-hook state, predetermined sound signals to the transmission source telephony device to cutoff communications between the transmission source telephony device and said telephony device.

23. A telephony device for transmitting sound signals based on received information to a transmission destination telephony device via a base station device to communicate with the transmission destination telephony device, said telephony device comprising
a transmission unit operable to transmit, before the transmission destination telephony device is in an off-hook state, transmission source information to the base station device,
wherein the base station device acquires the sound signals based on the transmission source information.

24. A base station device comprising:
a first acquiring unit operable to acquire an image based on transmission source information transmitted by a transmission source telephony device; and
a transmission unit operable to transmit, before a transmission destination telephony device is in an off-hook state, the image acquired by said first acquiring unit to the transmission destination telephony device.

25. The base station device of claim 24,
wherein the image acquired by said first acquiring unit comprises a face image.

26. The base station device of claim 24, further comprising
a second acquiring unit operable to acquire an image based on transmission destination information transmitted by the transmission source telephony device,
wherein said transmission unit is operable to transmit, before the off-hook state, the image acquired by the second acquiring unit to the transmission destination telephony device.

27. A base station device comprising:
an acquiring unit operable to acquire sound signals based on transmission source information transmitted by a transmission source telephony device; and
a transmission unit operable to transmit, before an off-hook state, the sound signals to a transmission destination telephony device.

28. The base station device of claim 24, further comprising
a connection control unit,
wherein said transmission unit is operable to transmit, after the off-hook state, a predetermined image to the transmission source telephony device according to a cutoff request signal transmitted by the transmission destination telephony device, and
wherein said connection control unit is operable to cut communications off between the transmission source telephony device and the transmission destination telephony device.

29. The base station device of claim 27, further comprising
a connection control unit,
wherein said transmission unit is operable to transmit, after the off-hook state, a predetermined image to the transmission source telephony device according to a cutoffrequest signal transmitted, after the off-hook state, by the transmission destination telephony device, and
wherein said connection control unit is operable to cut communications off between the transmission source telephony device and the transmission destination telephony device.

30. The base station device of claim 24, further comprising
a connection control unit,
wherein said transmission unit is operable to transmit, after the off-hook state, predetermined sound signals to the transmission source telephony device according to a cutoff request signal transmitted by the transmission destination telephony device, and
wherein said connection control unit is operable to cut communications off between the transmission source telephony device and the transmission destination telephony device.

31. The base station device of claim 27, further comprising
a connection control unit,
wherein said transmission unit is operable to transmit, after the off-hook state, predetermined sound signals to the transmission source telephony device according to a cutoff request signal transmitted, after the off-hook state, by the transmission destination telephony device, and
wherein said connection control unit is operable to cut communications off between the transmission source telephony device and the transmission destination telephony device.

32. A communication method comprising
transmitting multimedia information to a transmission destination telephony device before the transmission destination telephony device is in an off-hook state.
